(19) United States
(12) Patent Application Publication
(10) Pub. No.: US 2017/0041928 A1
(43) Pub. Date: Feb. 9, 2017

(54) METHOD AND DEVICE FOR GENERATING SEQUENCE FOR STF FIELD IN WIRELESS LAN SYSTEM

(71) Applicant: LG ELECTRONICS INC., Seoul (KR)

(72) Inventors: Eunsung PARK, Seoul (KR); Jinsoo CHOI, Seoul (KR); Hangyu CHO, Seoul (KR)

(73) Assignee: LG ELECTRONICS INC., Seoul (KR)

(21) Appl. No.: 15/227,862

(22) Filed: Aug. 3, 2016

Related U.S. Application Data
(60) Provisional application No. 62/200,655, filed on Aug. 4, 2015.
(60) Provisional application No. 62/200,660, filed on Aug. 4, 2015.
(60) Provisional application No. 62/201,080, filed on Aug. 4, 2015.
(60) Provisional application No. 62/201,565, filed on Aug. 5, 2015.

(51) Int. Cl. H04W 72/04; H04B 7/04

(52) U.S. Cl. CPC H04W 72/0446; H04W 72/0413; H04W 72/0453; H04B 7/0413; H04W 84/12

(57) ABSTRACT

Proposed herein is method and device for generating a sequence for a STF field in a wireless LAN system. A STF signal is included in a field that is used for enhancing AGC estimation of a MUMO transmission. The STF signal is used for an uplink transmission, and the STF signal may be used for an uplink MU PPDU STF, which is transmitted from multiple STAs. The STF signal may be used for at least any one of a first frequency band and a second frequency band, and wherein a first frequency bandwidth may correspond to 20 MHz, and a second frequency bandwidth may correspond to 40 MHz. The STF signal may be generated based on a M sequence. In case the STF signal is being used for the first frequency band, the STF signal may be generated from a {C1*M, 0, C2*M} sequence.

### CROSS-REFERENCE TO RELATED APPLICATION

Pursuant to 35 U.S.C. §119(e), this Applicant claims the benefit of U.S. Provisional Application No. 62/200,655, filed on Aug. 4, 2015, 62/200,660, filed on Aug. 4, 2015, 62/201,080, filed on Aug. 4, 2015, and 62/201,565, filed on Aug. 5, 2015, the contents of which are all hereby incorporated by reference herein in their entirety.

### BACKGROUND

Technical Field

This specification relates to an uplink transmission in a wireless LAN system, and more particularly, to a method for processing an uplink unit for multiple users in a wireless LAN system. This specification relates to a method for generating a sequence for a training field in a wireless LAN system and, more particularly, to a method and device for generating a shirt training field (STF) sequence that is available for usage in multiple bands in a wireless LAN system.

Description of the Related Art

Discussion for a next-generation wireless local area network (WLAN) is in progress. In the next-generation WLAN, an object is to 1) improve an institute of electronic and electronics engineers (IEEE) 802.11 physical (PHY) layer and a medium access control (MAC) layer in bands of 2.4 GHz and 5 GHz, 2) increase spectrum efficiency and area throughput, 3) improve performance in actual indoor and outdoor environments such as an environment in which an interference source exists, a dense heterogeneous network environment, and an environment in which a high user load exists, and the like.

An environment which is primarily considered in the next-generation WLAN is a dense environment in which access points (APs) and stations (STAs) are a lot and under the dense environment, improvement of the spectrum efficiency and the area throughput is discussed. Further, in the next-generation WLAN, in addition to the indoor environment, in the outdoor environment which is not considerably considered in the existing WLAN, substantial performance improvement is concerned.

In detail, scenarios such as wireless office, smart home, stadium, Hotspot, and building/apartment are largely concerned in the next-generation WLAN and discussion about improvement of system performance in a dense environment in which the APs and the STAs are a lot is performed based on the corresponding scenarios.

In the next-generation WLAN, improvement of system performance in an overlapping basic service set (OBSS) environment and improvement of outdoor environment performance, and cellular offloading are anticipated to be actively discussed rather than improvement of single link performance in one basic service set (BSS). Directionality of the next-generation means that the next-generation WLAN gradually has a technical scope similar to mobile communication. When a situation is considered, in which the mobile communication and the WLAN technology have been discussed in a small cell and a direct-to-direct (D2D) communication area in recent years, technical and business convergence of the next-generation WLAN and the mobile communication is predicted to be further active.

### SUMMARY OF THE INVENTION

### Technical Objects

This specification proposes a method and device for configuring a sequence that is used for a training field in a wireless LAN system.

An example of this specification proposes a method for enhancing the problems occurring in the sequence for the STF field, which is proposed in the related art.

### Technical Solutions

An example of the present invention proposes a transmission method that is applicable to a wireless LAN system.

More specifically, the method includes the steps of configuring, by a transmitting device of a wireless LAN system, a STF signal being used for enhancing AGC estimation of a MIMO transmission, and transmitting a PPDU including the STF signal to a receiving device.

In this case, the STF signal may be used for at least any one of a first frequency band and a second frequency band, and a second frequency bandwidth may be two times larger than a first frequency bandwidth.

The STF signal may be generated based on a M sequence, and, in case the STF signal is being used for the first frequency band, the STF signal may be generated from a {C1*M, 0, C2*M} sequence, and C1 and C2 may be coefficients.

In case the STF signal is being used for the second frequency band, the STF signal may be generated from a {C3*M, C4*M, 0, C5*M, C6*M} sequence, and C3, C4, C5, and C6 may be coefficients.

The M sequence may be defined as M={−1, −1, −1, 1, 1, 1, −1, 1, 1, 1, −1, 1, 1, −1, 1}*(1+j)+sqrt(½).

The above-described method is also applicable to an AP device and/or a non-AP device of a wireless LAN system.

### BRIEF DESCRIPTION OF THE DRAWINGS

FIG. 1 is a conceptual view illustrating the structure of a wireless local area network (WLAN).

FIG. 2 is a diagram illustrating an example of a PPDU used in an IEEE standard.

FIG. 3 is a diagram illustrating an example of an HE PDDU.

FIG. 4 is a diagram illustrating a layout of resource units (RUs) used in a band of 20 MHz.

FIG. 5 is a diagram illustrating a layout of resource units (RUs) used in a band of 40 MHz.

FIG. 6 is a diagram illustrating a layout of resource units (RUs) used in a band of 80 MHz.

FIG. 7 is a diagram illustrating another example of the HE PPDU.

FIG. 8 is a block diagram illustrating one example of HE-SIG-B according to an embodiment.

FIG. 9 illustrates an example of a trigger frame.

FIG. 10 illustrates an example of a common information field.

FIG. 11 illustrates an example of a sub-field being included in a per user information field.

FIG. 12 is a block diagram illustrating an example of an uplink MU PPDU.

FIG. 13 illustrates a 1×HE-STF tone in a per-channel PPDU transmission according to an exemplary embodiment of the present invention.

FIG. 14 illustrates a 2×HE-STF tone in a per-channel PPDU transmission according to an exemplary embodiment of the present invention.

FIG. 15 is a flow chart of a procedure according to an exemplary embodiment of the present invention.

FIG. 16 is a block diagram showing a wireless communication system in which the exemplary embodiment of the present invention can be applied.

### DESCRIPTION OF EXEMPLARY EMBODIMENTS

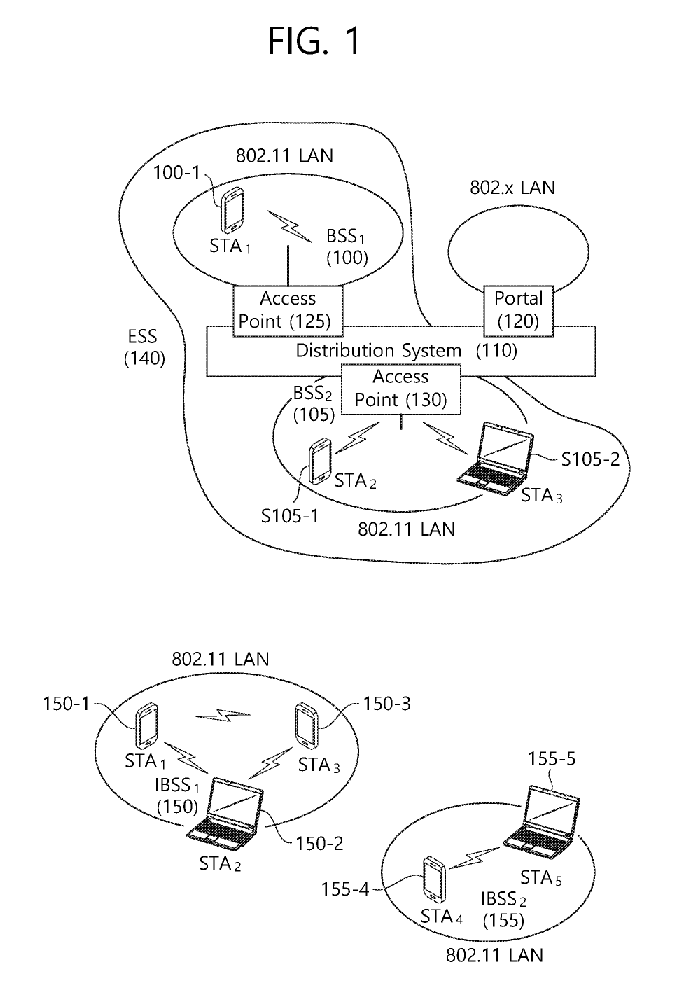

FIG. 1 is a conceptual view illustrating the structure of a wireless local area network (WLAN).

An upper part of FIG. 1 illustrates the structure of an infrastructure basic service set (BSS) of institute of electrical and electronic engineers (IEEE) 802.11.

Referring the upper part of FIG. 1, the wireless LAN system may include one or more infrastructure BSSs 100 and 105 (hereinafter, referred to as BSS). The BSSs 100 and 105 as a set of an AP and an STA such as an access point (AP) 125 and a station (STA1) 100-1 which are successfully synchronized to communicate with each other are not concepts indicating a specific region. The BSS 105 may include one or more STAs 105-1 and 105-2 which may be joined to one AP 130.

The BSS may include at least one STA, APs providing a distribution service, and a distribution system (DS) 110 connecting multiple APs.

The distribution system 110 may implement an extended service set (ESS) 140 extended by connecting the multiple BSSs 100 and 105. The ESS 140 may be used as a term indicating one network configured by connecting one or more APs 125 or 230 through the distribution system 110. The AP included in one ESS 140 may have the same service set identification (SSID).

A portal 120 may serve as a bridge which connects the wireless LAN network (IEEE 802.11) and another network (e.g., 802.X).

In the BSS illustrated in the upper part of FIG. 1, a network between the APs 125 and 130 and a network between the APs 125 and 130 and the STAs 100-1, 105-1, and 105-2 may be implemented. However, the network is configured even between the STAs without the APs 125 and 130 to perform communication. A network in which the communication is performed by configuring the network even between the STAs without the APs 125 and 130 is defined as an Ad-Hoc network or an independent basic service set (IBSS).

A lower part of FIG. 1 illustrates a conceptual view illustrating the IBSS.

Referring to the lower part of FIG. 1, the IBSS is a BSS that operates in an Ad-Hoc mode. Since the IBSS does not include the access point (AP), a centralized management entity that performs a management function at the center does not exist. That is, in the IBSS, STAs 150-1, 150-2, 150-3, 155-4, and 155-5 are managed by a distributed manner. In the IBSS, all STAs 150-1, 150-2, 150-3, 155-4, and 155-5 may be constituted by movable STAs and are not permitted to access the DS to constitute a self-contained network.

The STA as a predetermined functional medium that includes a medium access control (MAC) that follows a regulation of an Institute of Electrical and Electronics Engineers (IEEE) 802.11 standard and a physical layer interface for a radio medium may be used as a meaning including all of the APs and the non-AP stations (STAs).

The STA may be called various a name such as a mobile terminal, a wireless device, a wireless transmit/receive unit (WTRU), user equipment (UE), a mobile station (MS), a mobile subscriber unit, or just a user.

Meanwhile, the term user may be used in diverse meanings, for example, in wireless LAN communication, this term may be used to signify a STA participating in uplink MU MIMO and/or uplink OFDMA transmission. However, the meaning of this term will not be limited only to this.

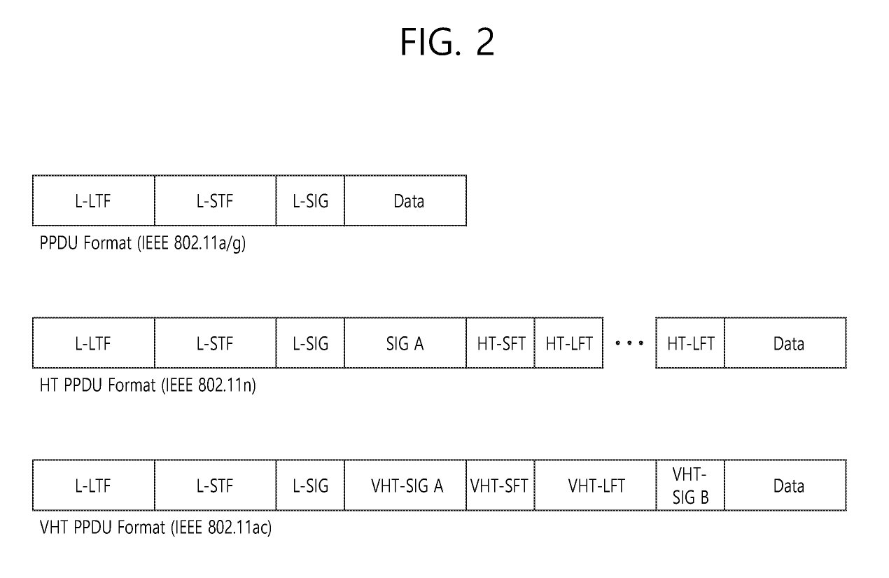

FIG. 2 is a diagram illustrating an example of a PPDU used in an IEEE standard.

As illustrated in FIG. 2, various types of PHY protocol data units (PPDUs) may be used in a standard such as IEEE a/g/n/ac, etc. In detail, LTF and STF fields include a training signal, SIG-A and SIG-B include control information for a receiving station, and a data field includes user data corresponding to a PSDU.

In the embodiment, an improved technique is provided, which is associated with a signal (alternatively, a control information field) used for the data field of the PPDU. The signal provided in the embodiment may be applied onto high efficiency PPDU (HE PPDU) according to an IEEE 802.11ax standard. That is, the signal improved in the embodiment may be HE-SIG-A and/or HE-SIG-B included in the HE PPDU. The HE-SIG-A and the HE-SIG-B may be represented even as the SIG-A and SIG-B, respectively. However, the improved signal proposed in the embodiment is not particularly limited to an HE-SIG-A and/or HE-SIG-B standard and may be applied to control/data fields having various names, which include the control information in a wireless communication system transferring the user data.

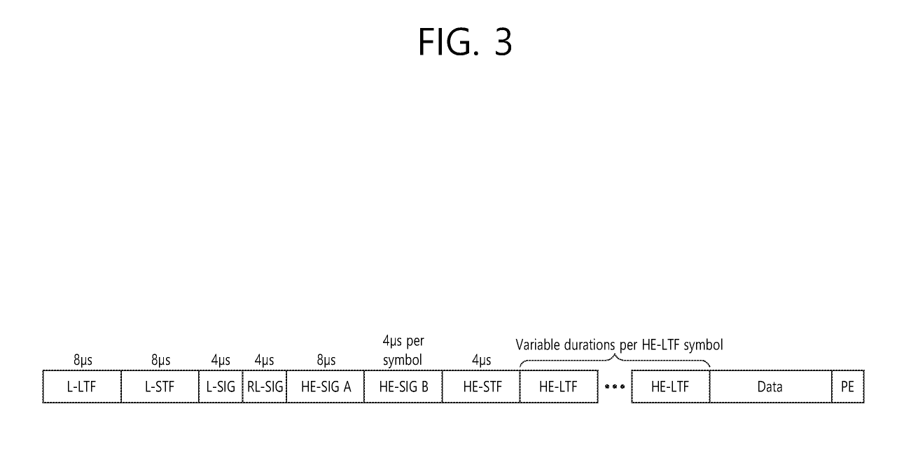

FIG. 3 is a diagram illustrating an example of an HE PDDU.

The control information field provided in the embodiment may be the HE-SIG-B included in the HE PPDU. The HE PPDU according to FIG. 3 is one example of the PPDU for multiple users and only the PPDU for the multiple users may include the HE-SIG-B and the corresponding HE SIG-B may be omitted in a PPDU for a single user.

As illustrated in FIG. 3, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted during an illustrated time period (that is, 4 or 8 μs).

More detailed description of the respective fields of FIG. 3 will be made below.

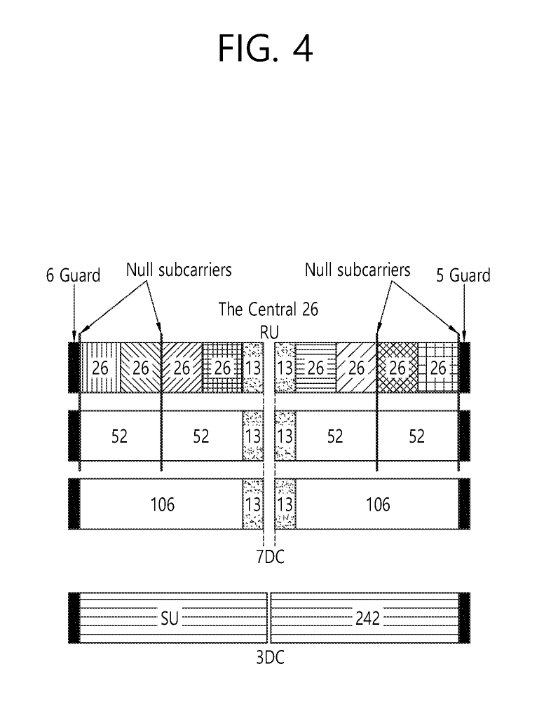

FIG. 4 is a diagram illustrating a layout of resource units (RUs) used in a band of 20 MHz.

As illustrated in FIG. 4, resource units (RUs) corresponding to tone (that is, subcarriers) of different numbers are used to constitute some fields of the HE-PPDU. For example, the resources may be allocated by the unit of the RU illustrated with respect to the HE-STF, the HE-LTF, and the data field.

As illustrated in an uppermost part of FIG. 4, 26 units (that is, units corresponding to 26 tones). 6 tones may be used as a guard band in a leftmost band of the 20 MHz band and 5 tones may be used as the guard band in a rightmost band of the 20 MHz band. Further, 7 DC tones may be inserted into a center band, that is, a DC band and a 26-unit corresponding to each 13 tones may be present at left and right sides of the DC band. The 26-unit, a 52-unit, and a 106-unit may be allocated to other bands. Each unit may be allocated for a receiving station, that is, a user.

Meanwhile, the RU layout of FIG. 4 may be used even in a situation for a single user (SU) in addition to the multiple users (MUs) and in this case, as illustrated in a lowermost part of FIG. 4, one 242-unit may be used and in this case, three DC tones may be inserted.

In one example of FIG. 4, RUs having various sizes, that is, a 26-RU, a 52-RU, a 106-RU, a 242-RU, and the like are proposed, and as a result, since detailed sizes of the RUs may extend or increase, the embodiment is not limited to a detailed size (that is, the number of corresponding tones) of each RU.

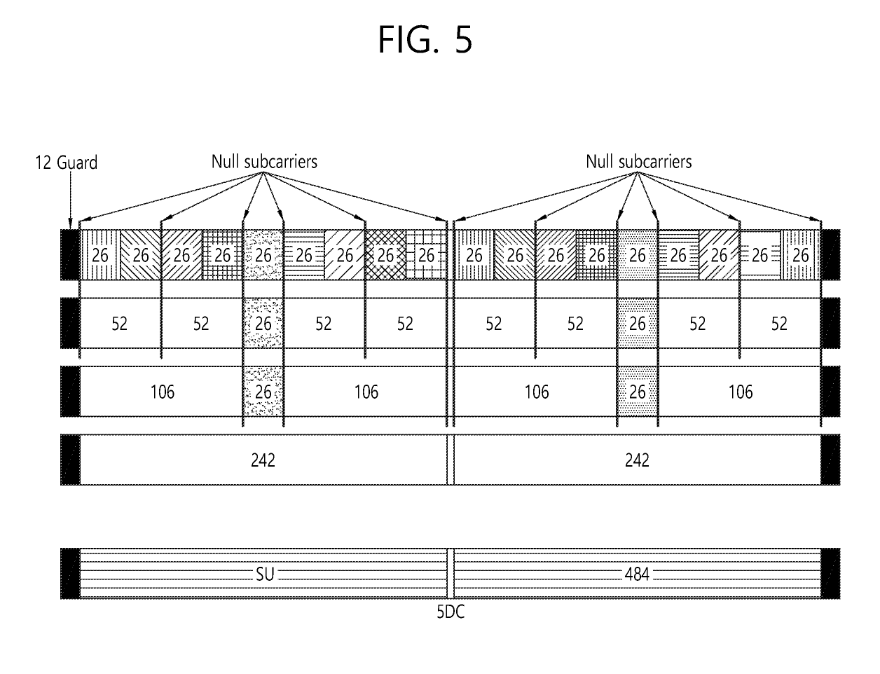

FIG. 5 is a diagram illustrating a layout of resource units (RUs) used in a band of 40 MHz.

Similarly to a case in which the RUs having various RUs are used in one example of FIG. 4, 26-RU, 52-RU, 106-RU, 242-RU, 484-RU, and the like may be used even in one example of FIG. 5. Further, 5 DC tones may be inserted into a center frequency, 12 tones may be used as the guard band in the leftmost band of the 40 MHz band and 11 tones may be used as the guard band in the rightmost band of the 40 MHz band.

In addition, as illustrated in FIG. 5, when the RU layout is used for the single user, the 484-RU may be used. That is, the detailed number of RUs may be modified similarly to one example of FIG. 4.

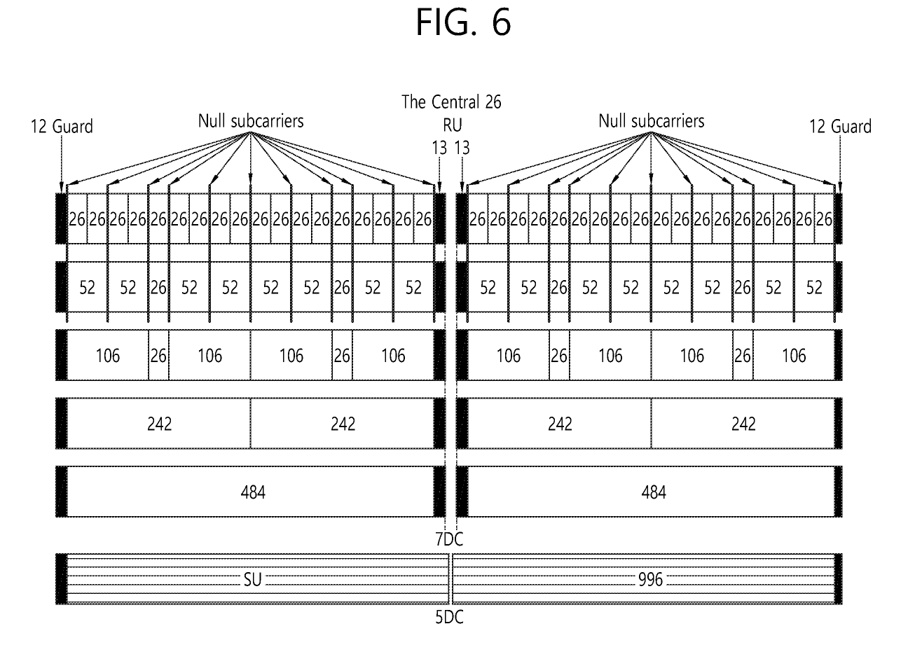

FIG. 6 is a diagram illustrating a layout of resource units (RUs) used in a band of 80 MHz.

Similarly to a case in which the RUs having various RUs are used in one example of each of FIG. 4 or 5, 26-RU, 52-RU, 106-RU, 242-RU, 484-RU, and the like may be used even in one example of FIG. 6. Further, 7 DC tones may be inserted into the center frequency, 12 tones may be used as the guard band in the leftmost band of the 80 MHz band and 11 tones may be used as the guard band in the rightmost band of the 80 MHz band. In addition, the 26-RU may be used, which uses 13 tones positioned at each of left and right sides of the DC band.

Moreover, as illustrated in FIG. 6, when the RU layout is used for the single user, 996-RU may be used and in this case, 5 DC tones may be inserted.

Meanwhile, the detailed number of RUs may be modified similarly to one example of each of FIG. 4 or 5.

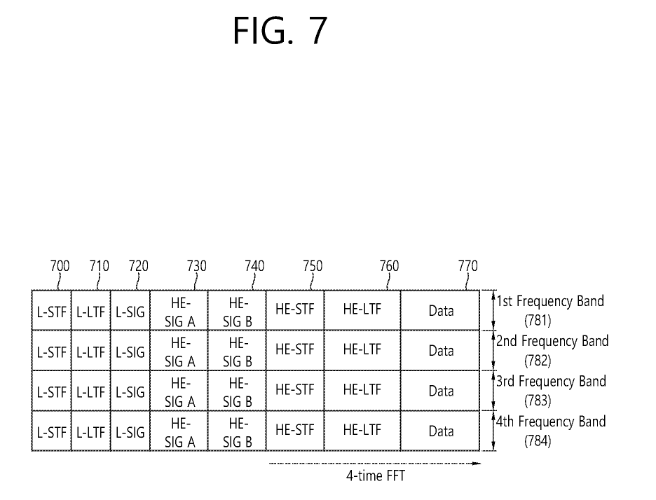

FIG. 7 is a diagram illustrating another example of the HE PPDU.

A block illustrated in FIG. 7 is another example of describing the HE-PPDU block of FIG. 3 in terms of a frequency.

An illustrated L-STF 700 may include a short training orthogonal frequency division multiplexing (OFDM) symbol. The L-STF 700 may be used for frame detection, automatic gain control (AGC), diversity detection, and coarse frequency/time synchronization.

An L-LTF 710 may include a long training orthogonal frequency division multiplexing (OFDM) symbol. The L-LTF 710 may be used for fine frequency/time synchronization and channel prediction.

An L-SIG 720 may be used for transmitting control information. The L-SIG 720 may include information regarding a data rate and a data length. Further, the L-SIG 720 may be repeatedly transmitted. That is, a new format, in which the L-SIG 720 is repeated (for example, may be referred to as R-LSIG) may be configured.

An HE-SIG-A 730 may include the control information common to the receiving station.

In detail, the HE-SIG-A 730 may include information on 1) a DL/UL indicator, 2) a BSS color field indicating an identify of a BSS, 3) a field indicating a remaining time of a current TXOP period, 4) a bandwidth field indicating at least one of 20, 40, 80, 160 and 80+80 MHz, 5) a field indicating an MCS technique applied to the HE-SIG-B, 6) an indication field regarding whether the HE-SIG-B is modulated by a dual subcarrier modulation technique for MCS, 7) a field indicating the number of symbols used for the HE-SIG-B, 8) a field indicating whether the HE-SIG-B is configured for a full bandwidth MIMO transmission, 9) a field indicating the number of symbols of the HE-LTF, 10) a field indicating the length of the HE-LTF and a CP length, 11) a field indicating whether an OFDM symbol is present for LDPC coding, 12) a field indicating control information regarding packet extension (PE), 13) a field indicating information on a CRC field of the HE-SIG-A, and the like. A detailed field of the HE-SIG-A may be added or partially omitted. Further, some fields of the HE-SIG-A may be partially added or omitted in other environments other than a multi-user (MU) environment.

An HE-SIG-B 740 may be included only in the case of the PPDU for the multiple users (MUs) as described above. Principally, an HE-SIG-A 750 or an HE-SIG-B 760 may include resource allocation information (alternatively, virtual resource allocation information) for at least one receiving STA.

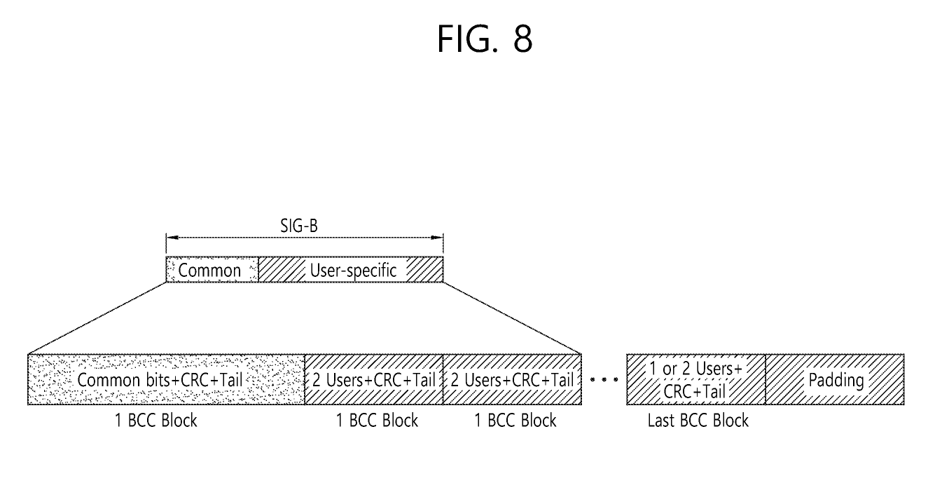

FIG. 8 is a block diagram illustrating one example of HE-SIG-B according to an embodiment.

As illustrated in FIG. 8, the HE-SIG-B field includes a common field at a frontmost part and the corresponding common field is separated from a field which follows therebehind to be encoded. That is, as illustrated in FIG. 8, the HE-SIG-B field may include a common field including the common control information and a user-specific field including user-specific control information. In this case, the common field may include a CRC field corresponding to the common field, and the like and may be coded to be one BCC block. The user-specific field subsequent thereafter may be coded to be one BCC block including the “user-specific field” for 2 users and a CRC field corresponding thereto as illustrated in FIG. 8.

A previous field of the HE-SIG-B 740 may be transmitted in a duplicated form on an MU PPDU. In the case of the HE-SIG-B 740, the HE-SIG-B 740 transmitted in some frequency band (e.g., a fourth frequency band) may even include control information for a data field corresponding to a corresponding frequency band (that is, the fourth frequency band) and a data field of another frequency band (e.g., a second frequency band) other than the corresponding frequency band. Further, a format may be provided, in which the HE-SIG-B 740 in a specific frequency band (e.g., the second frequency band) is duplicated with the HE-SIG-B 740 of another frequency band (e.g., the fourth frequency band). Alternatively, the HE-SIG B 740 may be transmitted in an encoded form on all transmission resources. A field after the HE-SIG B 740 may include individual information for respective receiving STAs receiving the PPDU.

The HE-STF 750 may be used for improving automatic gain control estimation in a multiple input multiple output (MIMO) environment or an OFDMA environment.

The HE-LTF 760 may be used for estimating a channel in the MIMO environment or the OFDMA environment.

The size of fast Fourier transform (FFT)/inverse fast Fourier transform (IFFT) applied to the HE-STF 750 and the field after the HE-STF 750, and the size of the FFT/IFFT applied to the field before the HE-STF 750 may be different from each other. For example, the size of the FFT/IFFT applied to the HE-STF 750 and the field after the HE-STF 750 may be four times larger than the size of the FFT/IFFT applied to the field before the HE-STF 750.

For example, when at least one field of the L-STF 700, the L-LTF 710, the L-SIG 720, the HE-SIG-A 730, and the HE-SIG-B 740 on the PPDU of FIG. 7 is referred to as a first field, at least one of the data field 770, the HE-STF 750, and the HE-LTF 760 may be referred to as a second field. The first field may include a field associated with a legacy system and the second field may include a field associated with an HE system. In this case, the fast Fourier transform (FFT) size and the inverse fast Fourier transform (IFFT) size may be defined as a size which is N (N is a natural number, e.g., N=1, 2, and 4) times larger than the FFT/IFFT size used in the legacy wireless LAN system. That is, the FFT/IFFT having the size may be applied, which is N (=4) times larger than the first field of the HE PPDU. For example, 256 FFT/IFFT may be applied to a bandwidth of 20 MHz, 512 FFT/IFFT may be applied to a bandwidth of 40 MHz, 1024 FFT/IFFT may be applied to a bandwidth of 80 MHz, and 2048 FFT/IFFT may be applied to a bandwidth of continuous 160 MHz or discontinuous 160 MHz.

In other words, a subcarrier space/subcarrier spacing may have a size which is 1/N times (N is the natural number, e.g., N=4, the subcarrier spacing is set to 78.125 kHz) the subcarrier space used in the legacy wireless LAN system. That is, subcarrier spacing having a size of 312.5 kHz, which is legacy subcarrier spacing may be applied to the first field of the HE PPDU and a subcarrier space having a size of 78.125 kHz may be applied to the second field of the HE PPDU.

Alternatively, an IDFT/DFT period applied to each symbol of the first field may be expressed to be N (=4) times shorter than the IDFT/DFT period applied to each data symbol of the second field. That is, the IDFT/DFT length applied to each symbol of the first field of the HE PPDU may be expressed as 3.2 μs and the IDFT/DFT length applied to each symbol of the second field of the HE PPDU may be expressed as 3.2 μs*4 (=12.8 μs). The length of the OFDM symbol may be a value acquired by adding the length of a guard interval (GI) to the IDFT/DFT length. The length of the GI may have various values such as 0.4 μs, 0.8 μs, 1.6 μs, 2.4 μs, and 3.2 μs.

For simplicity in the description, in FIG. 7, it is expressed that a frequency band used by the first field and a frequency band used by the second field accurately coincide with each other, but both frequency bands may not completely coincide with each other, in actual. For example, a primary band of the first field (L-STF, L-LTF, L-SIG, HE-SIG-A, and HE-SIG-B) corresponding to the first frequency band may be the same as the most portions of a frequency band of the second field (HE-STF, HE-LTF, and Data), but boundary surfaces of the respective frequency bands may not coincide with each other. As illustrated in FIGS. 4 to 6, since multiple null subcarriers, DC tones, guard tones, and the like are inserted during arranging the RUs, it may be difficult to accurately adjust the boundary surfaces.

The user (e.g., a receiving station) may receive the HE-SIG-A 730 and may be instructed to receive the downlink PPDU based on the HE-SIG-A 730. In this case, the STA may perform decoding based on the FFT size changed from the HE-STF 750 and the field after the HE-STF 750. On the contrary, when the STA may not be instructed to receive the downlink PPDU based on the HE-SIG-A 730, the STA may stop the decoding and configure a network allocation vector (NAV). A cyclic prefix (CP) of the HE-STF 750 may have a larger size than the CP of another field and the during the CP period, the STA may perform the decoding for the downlink PPDU by changing the FFT size.

Hereinafter, in the embodiment of the present invention, data (alternatively, or a frame) which the AP transmits to the STA may be expressed as a terms called downlink data (alternatively, a downlink frame) and data (alternatively, a frame) which the STA transmits to the AP may be expressed as a term called uplink data (alternatively, an uplink frame). Further, transmission from the AP to the STA may be expressed as downlink transmission and transmission from the STA to the AP may be expressed as a term called uplink transmission.

In addition, a PHY protocol data unit (PPDU), a frame, and data transmitted through the downlink transmission may be expressed as terms such as a downlink PPDU, a downlink frame, and downlink data, respectively. The PPDU may be a data unit including a PPDU header and a physical layer service data unit (PSDU) (alternatively, a MAC protocol data unit (MPDU)). The PPDU header may include a PHY header and a PHY preamble and the PSDU (alternatively, MPDU) may include the frame or indicate the frame (alternatively, an information unit of the MAC layer) or be a data unit indicating the frame. The PHY header may be expressed as a physical layer convergence protocol (PLCP) header as another term and the PHY preamble may be expressed as a PLCP preamble as another term.

Further, a PPDU, a frame, and data transmitted through the uplink transmission may be expressed as terms such as an uplink PPDU, an uplink frame, and uplink data, respectively.

In the wireless LAN system to which the embodiment of the present description is applied, the whole bandwidth may be used for downlink transmission to one STA and uplink transmission to one STA. Further, in the wireless LAN system to which the embodiment of the present description is applied, the AP may perform downlink (DL) multi-user (MU) transmission based on multiple input multiple output (MU MIMO) and the transmission may be expressed as a term called DL MU MIMO transmission.

In addition, in the wireless LAN system according to the embodiment, an orthogonal frequency division multiple access (OFDMA) based transmission method is preferably supported for the uplink transmission and/or downlink transmission. That is, data units (e.g., RUs) corresponding to different frequency resources are allocated to the user to perform uplink/downlink communication. In detail, in the wireless LAN system according to the embodiment, the AP may perform the DL MU transmission based on the OFDMA and the transmission may be expressed as a term called DL MU OFDMA transmission. When the DL MU OFDMA transmission is performed, the AP may transmit the downlink data (alternatively, the downlink frame and the downlink PPDU) to the plurality of respective STAs through the plurality of respective frequency resources on an overlapped time resource. The plurality of frequency resources may be a plurality of subbands (alternatively, sub channels) or a plurality of resource units (RUs). The DL MU OFDMA transmission may be used together with the DL MU MIMO transmission. For example, the DL MU MIMO transmission based on a plurality of space-time streams (alternatively, spatial streams) may be performed on a specific subband (alternatively, sub channel) allocated for the DL MU OFDMA transmission.

Further, in the wireless LAN system according to the embodiment, uplink multi-user (UL MU) transmission in which the plurality of STAs transmits data to the AP on the same time resource may be supported. Uplink transmission on the overlapped time resource by the plurality of respective STAs may be performed on a frequency domain or a spatial domain.

When the uplink transmission by the plurality of respective STAs is performed on the frequency domain, different frequency resources may be allocated to the plurality of respective STAs as uplink transmission resources based on the OFDMA. The different frequency resources may be different subbands (alternatively, sub channels) or different resources units (RUs). The plurality of respective STAs may transmit uplink data to the AP through different frequency resources. The transmission method through the different frequency resources may be expressed as a term called a UL MU OFDMA transmission method.

When the uplink transmission by the plurality of respective STAs is performed on the spatial domain, different time-space streams (alternatively, spatial streams) may be allocated to the plurality of respective STAs and the plurality of respective STAs may transmit the uplink data to the AP through the different time-space streams. The transmission method through the different spatial streams may be expressed as a term called a UL MU MIMO transmission method.

The UL MU OFDMA transmission and the UL MU MIMO transmission may be used together with each other. For example, the UL MU MIMO transmission based on the plurality of space-time streams (alternatively, spatial streams) may be performed on a specific subband (alternatively, sub channel) allocated for the UL MU OFDMA transmission.

In the legacy wireless LAN system which does not support the MU OFDMA transmission, a multi-channel allocation method is used for allocating a wider bandwidth (e.g., a 20 MHz excess bandwidth) to one terminal. When a channel unit is 20 MHz, multiple channels may include a plurality of 20 MHz-channels. In the multi-channel allocation method, a primary channel rule is used to allocate the wider bandwidth to the terminal. When the primary channel rule is used, there is a limit for allocating the wider bandwidth to the terminal. In detail, according to the primary channel rule, when a secondary channel adjacent to a primary channel is used in an overlapped BSS (OBSS) and is thus busy, the STA may use remaining channels other than the primary channel Therefore, since the STA may transmit the frame only to the primary channel, the STA receives a limit for transmission of the frame through the multiple channels. That is, in the legacy wireless LAN system, the primary channel rule used for allocating the multiple channels may be a large limit in obtaining a high throughput by operating the wider bandwidth in a current wireless LAN environment in which the OBSS is not small.

In order to solve the problem, in the embodiment, a wireless LAN system is disclosed, which supports the OFDMA technology. That is, the OFDMA technique may be applied to at least one of downlink and uplink. Further, the MU-MIMO technique may be additionally applied to at least one of downlink and uplink. When the OFDMA technique is used, the multiple channels may be simultaneously used by not one terminal but multiple terminals without the limit by the primary channel rule. Therefore, the wider bandwidth may be operated to improve efficiency of operating a wireless resource.

As described above, when the uplink transmission by the plurality of respective STAs (e.g., non-AP STAs) is performed on the frequency domain, the AP may allocate the different frequency resources to the plurality of respective STAs as the uplink transmission resources based on the OFDMA. Further, as described above, the different frequency resources may be different subbands (alternatively, sub channels) or different resources units (RUs).

The different frequency resources are indicated through a trigger frame with respect to the plurality of respective STAs.

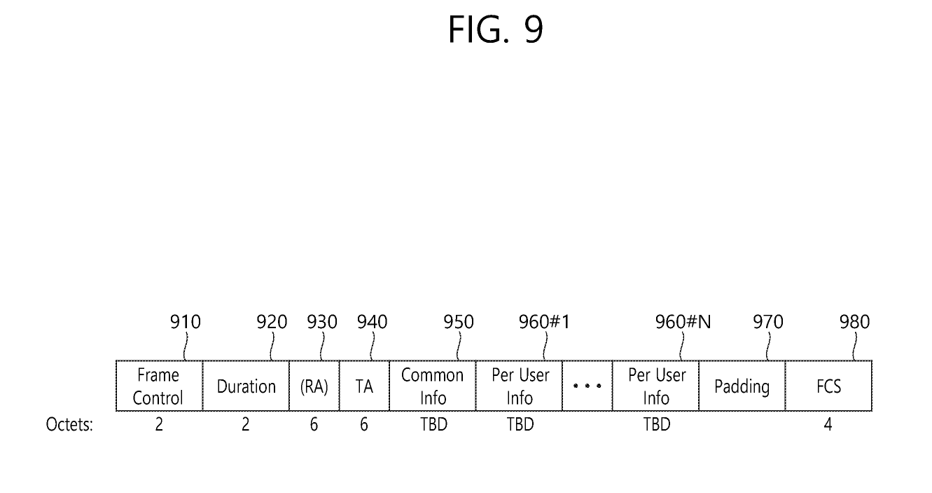

FIG. 9 illustrates an example of a trigger frame. The trigger frame of FIG. 9 allocates resources for Uplink Multiple-User (MU) transmission and may be transmitted from the AP. The trigger frame may be configured as a MAC frame and may be included in the PPDU. For example, the trigger frame may be transmitted through the PPDU shown in FIG. 3, through the legacy PPDU shown in FIG. 2, or through a certain PPDU, which is newly designed for the corresponding trigger frame. In case the trigger frame is transmitted through the PPDU of FIG. 3, the trigger frame may be included in the data field shown in the drawing.

Each of the fields shown in FIG. 9 may be partially omitted, or other fields may be added. Moreover, the length of each field may be varied differently as shown in the drawing.

A Frame Control field 910 shown in FIG. 9 may include information related to a version of the MAC protocol and other additional control information, and a Duration field 920 may include time information for configuring a NAV or information related to an identifier (e.g., AID) of the user equipment.

Additionally, a RA field 930 may include address information of a receiving STA of the corresponding trigger frame, and this field may also be omitted as required. A TA field 940 may include address information of the STA (e.g., AP) transmitting the corresponding trigger frame, and a common information field 950 may include common control information that is applied to the receiving STA receiving the corresponding trigger frame.

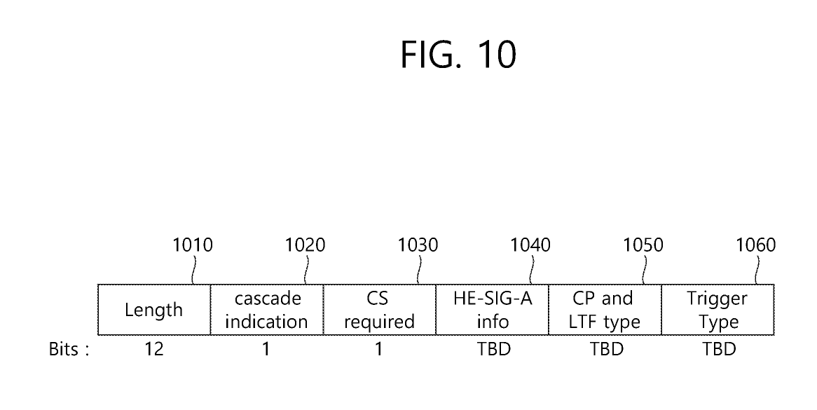

FIG. 10 illustrates an example of a common information field. Among the sub-fields of FIG. 10, some may be omitted, and other additional sub-fields may also be added. Additionally, the length of each of the sub-fields shown in the drawing may be varied.

As shown in the drawing, the Length field 1010 may be given that same value as the Length field of the L-SIG field of the uplink PPDU, which is transmitted with respect to the corresponding trigger frame, and the Length field of the L-SIG field of the uplink PPDU indicates the length of the uplink PPDU. As a result, the Length field 1010 of the trigger frame may be used for indicating the length of its respective uplink PPDU.

Additionally, a Cascade Indicator field 1020 indicates whether or not a cascade operation is performed. The cascade operation refers to a downlink MU transmission and an uplink MU transmission being performed simultaneously within the same TXOP. More specifically, this refers to a case when a downlink MU transmission is first performed, and, then, after a predetermined period of time (e.g., SIFS), an uplink MU transmission is performed. During the cascade operation, only one transmitting device performing downlink communication (e.g., AP) may exist, and multiple transmitting devices performing uplink communication (e.g., non-AP) may exist.

A CS Request field 1030 indicates whether or not the status or NAV of a wireless medium is required to be considered in a situation where a receiving device that has received the corresponding trigger frame transmits the respective uplink PPDU.

A HE-SIG-A information field 1040 may include information controlling the content of a SIG-A field (i.e., HE-SIG-A field) of an uplink PPDU, which is being transmitted with respect to the corresponding trigger frame.

A CP and LTF type field 1050 may include information on a LTF length and a CP length of the uplink PPDU being transmitted with respect to the corresponding trigger frame. A trigger type field 1060 may indicate a purpose for which the corresponding trigger frame is being used, e.g., general triggering, triggering for beamforming, and so on, a request for a Block ACK/NACK, and so on.

Meanwhile, the remaining description on FIG. 9 will be additionally provided as described below.

It is preferable that the trigger frame includes per user information fields 960#1 to 960#N corresponding to the number of receiving STAs receiving the trigger frame of FIG. 9. The per user information field may also be referred to as a “RU Allocation field”.

Additionally, the trigger frame of FIG. 9 may include a Padding field 970 and a Sequence field 980.

It is preferable that each of the per user information fields 960#1 to 960#N shown in FIG. 9 further includes multiple sub-fields.

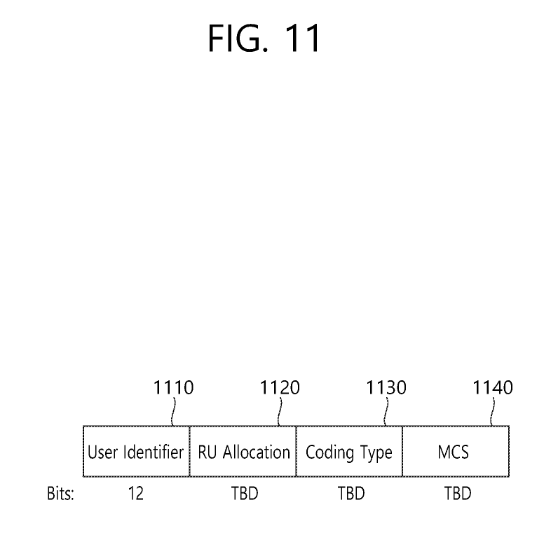

FIG. 11 illustrates an example of a sub-field being included in a per user information field. Among the sub-fields of FIG. 11, some may be omitted, and other additional sub-fields may also be added. Additionally, the length of each of the sub-fields shown in the drawing may be varied.

A User Identifier field 1110 indicates an identifier of an STA (i.e., receiving STA) to which the per user information corresponds, and an example of the identifier may correspond to all or part of the AID.

Additionally, a RU Allocation field 1120 may be included in the sub-field of the per user information field. More specifically, in case a receiving STA, which is identified by the User Identifier field 1110, transmits an uplink PPDU with respect to the trigger frame of FIG. 9, the corresponding uplink PPDU is transmitted through the RU, which is indicated by the RU Allocation field 1120. In this case, it is preferable that the RU that is being indicated by the RU Allocation field 1120 corresponds to the RU shown in FIG. 4, FIG. 5, and FIG. 6.

The sub-field of FIG. 11 may include a Coding Type field 1130. The Coding Type field 1130 may indicate a coding type of the uplink PPDU being transmitted with respect to the trigger frame of FIG. 9. For example, in case BBC coding is applied to the uplink PPDU, the Coding Type field 1130 may be set to ‘1’, and, in case LDPC coding is applied to the uplink PPDU, the Coding Type field 1130 may be set to ‘0’.

Additionally, the sub-field of FIG. 11 may include a MCS field 1140. The MCS field 1140 may indicate a MCS scheme being applied to the uplink PPDU that is transmitted with respect to the trigger frame of FIG. 9.

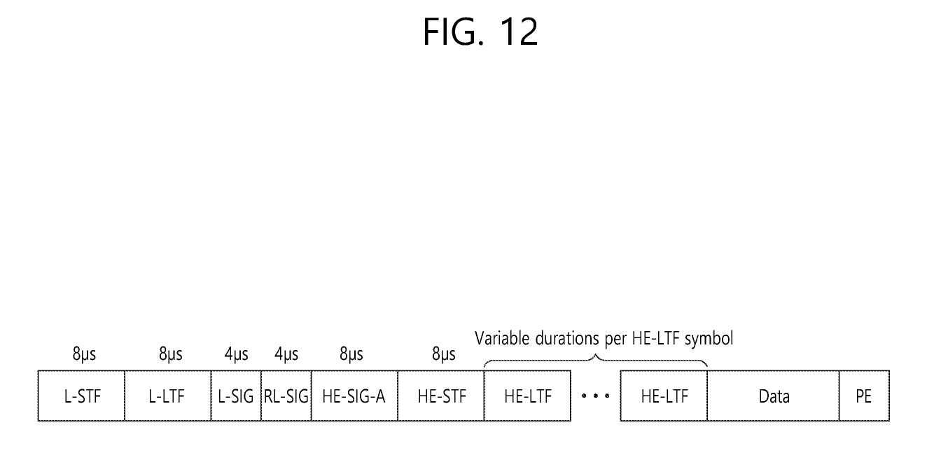

FIG. 12 is a block diagram illustrating an example of an uplink MU PPDU. The uplink MU PPDU of FIG. 12 may be transmitted with respect to the above-described trigger frame.

As shown in the drawing, the PPDU of FIG. 12 includes diverse fields, and the fields included herein respectively correspond to the fields shown in FIG. 2, FIG. 3, and FIG. 7. Meanwhile, as shown in the drawing, the uplink PPDU of FIG. 12 may not include a HE-SIG-B field and may only include a HE-SIG-A field.

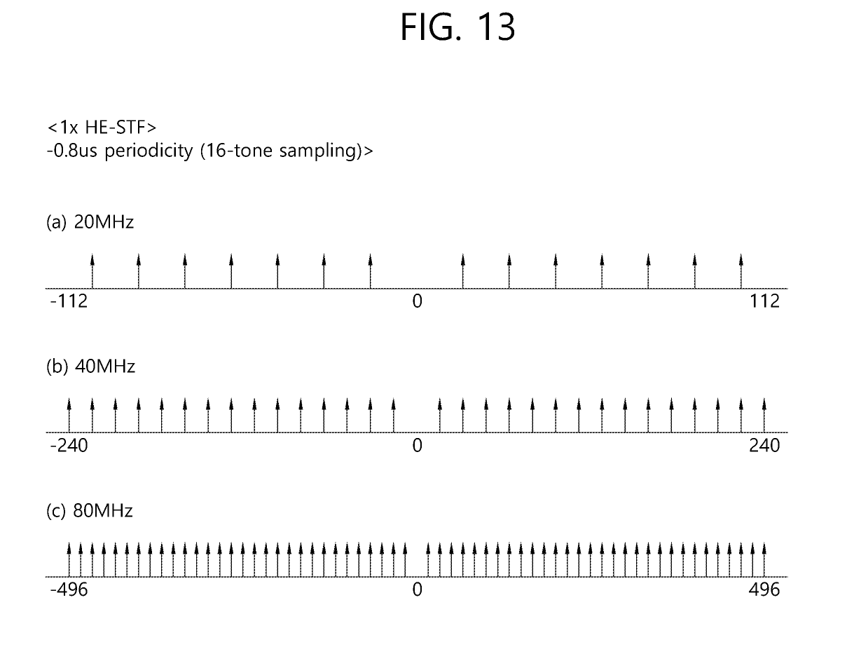

FIG. 13 illustrates a 1×HE-STF tone in a per-channel PPDU transmission according to an exemplary embodiment of the present invention. Most particularly, FIG. 13 shows an example of a HE-STF tone (i.e., 16-tone sampling) having a periodicity of 0.8 μs in 20 MHz/40 MHz/80 MHz bandwidths. Accordingly, in FIG. 13, the HE-STF tones for each bandwidth (or channel) may be positioned at 16 tone intervals.

In FIG. 13, the x-axis represents the frequency domain. The numbers on the x-axis represent the indexes of a tone, and the arrows represent mapping of a value that is not equal to 0 (i.e., a non-zero value) to the corresponding tone index.

Sub-drawing (a) of FIG. 13 illustrates an example of a 1×HE-STF tone in a 20 MHz PPDU transmission.

Referring to sub-drawing (a), in case a HE-STF sequence (i.e., 1×HE-STF sequence) for a periodicity of 0.8 μs is mapped to tones of a 20 MHz channel, the 1×HE-STF sequence is mapped to tones having tone indexes that are divisible by 16 (i.e., multiples of 16), among the tones having tone indexes ranging from −112 to 112, and, then, 0 may be mapped to the remaining tones. More specifically, in a 20 MHz channel, among the tones having tone indexes ranging from −112 to 112, a 1×HE-STF tone may be positioned at a tone index that is divisible by 16 excluding the DC. Accordingly, a total of 14 1×HE-STF tones having the 1×HE-STF sequence mapped thereto may exist in the 20 MHz channel.

Sub-drawing (b) of FIG. 13 illustrates an example of a 1×HE-STF tone in a 40 MHz PPDU transmission.

Referring to sub-drawing (b), in case a HE-STF sequence (i.e., 1×HE-STF sequence) for a periodicity of 0.8 μs is mapped to tones of a 40 MHz channel, the 1×HE-STF sequence is mapped to tones having tone indexes that are divisible by 16 (i.e., multiples of 16), among the tones having tone indexes ranging from −240 to 240, and, then, 0 may be mapped to the remaining tones. More specifically, in a 40 MHz channel, among the tones having tone indexes ranging from −240 to 240, a 1×HE-STF tone may be positioned at a tone index that is divisible by 16 excluding the DC. Accordingly, a total of 30 1×HE-STF tones having the 1×HE-STF sequence mapped thereto may exist in the 40 MHz channel.

Sub-drawing (c) of FIG. 13 illustrates an example of a 1×HE-STF tone in an 80 MHz PPDU transmission.

Referring to sub-drawing (c), in case a HE-STF sequence (i.e., 1×HE-STF sequence) for a periodicity of 0.8 μs is mapped to tones of a 80 MHz channel, the 1×HE-STF sequence is mapped to tones having tone indexes that are divisible by 16 (i.e., multiples of 16), among the tones having tone indexes ranging from −496 to 496, and, then, 0 may be mapped to the remaining tones. More specifically, in an 80 MHz channel, among the tones having tone indexes ranging from −496 to 496, a 1×HE-STF tone may be positioned at a tone index that is divisible by 16 excluding the DC. Accordingly, a total of 62 1×HE-STF tones having the 1×HE-STF sequence mapped thereto may exist in the 80 MHz channel.

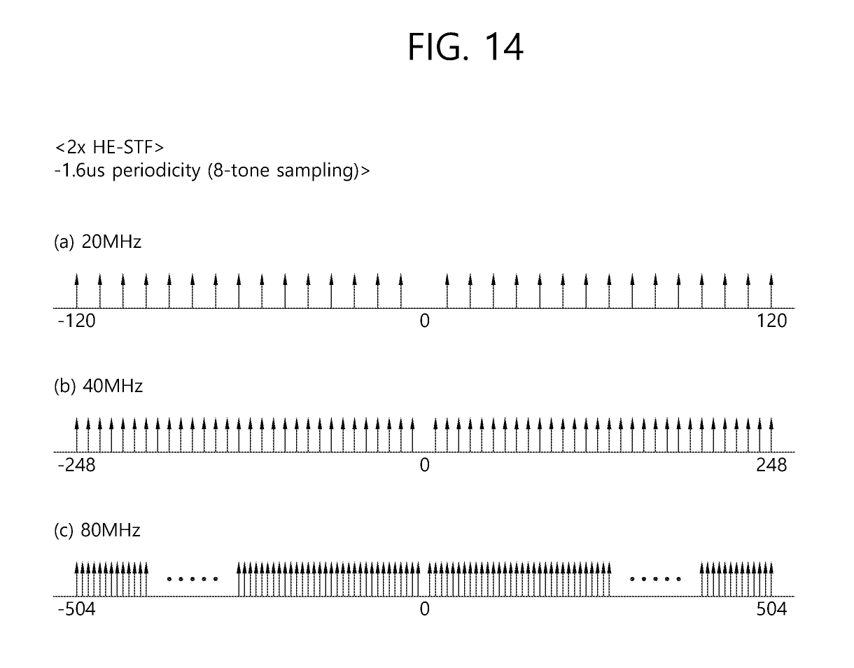

FIG. 14 illustrates a 2×HE-STF tone in a per-channel PPDU transmission according to an exemplary embodiment of the present invention. Most particularly, FIG. 14 shows an example of a HE-STF tone (i.e., 8-tone sampling) having a periodicity of 1.6 μs in 20 MHz/40 MHz/80 MHz bandwidths. Accordingly, in FIG. 14, the HE-STF tones for each bandwidth (or channel) may be positioned at 8 tone intervals.

The 2×HE-STF signal according to FIG. 14 may be applied to the uplink MU PPDU shown in FIG. 12. More specifically, the 2×HE-STF signal shown in FIG. 14 may be included in the PPDU, which is transmitted via uplink with respect to the above-described trigger frame.

In FIG. 14, the x-axis represents the frequency domain. The numbers on the x-axis represent the indexes of a tone, and the arrows represent mapping of a value that is not equal to 0 (i.e., a non-zero value) to the corresponding tone index.

Sub-drawing (a) of FIG. 14 is a drawing showing an example of a 2×HE-STF tone in a 20 MHz PPDU transmission.

Referring to sub-drawing (a), in case a HE-STF sequence (i.e., 2×HE-STF sequence) for a periodicity of 1.6 μs is mapped to tones of a 20 MHz channel, the 2×HE-STF sequence is mapped to tones having tone indexes that are divisible by 8 (i.e., multiples of 8), among the tones having tone indexes ranging from −120 to 120, and, then, 0 may be mapped to the remaining tones. More specifically, in a 20 MHz channel, among the tones having tone indexes ranging from −120 to 120, a 2×HE-STF tone may be positioned at a tone index that is divisible by 8 excluding the DC. Accordingly, a total of 30 2×HE-STF tones having the 2×HE-STF sequence mapped thereto may exist in the 20 MHz channel.

Sub-drawing (b) of FIG. 14 illustrates an example of a 2×HE-STF tone in a 40 MHz PPDU transmission.

Referring to sub-drawing (b), in case a HE-STF sequence (i.e., 2×HE-STF sequence) for a periodicity of 1.6 μs is mapped to tones of a 40 MHz channel, the 2×HE-STF sequence is mapped to tones having tone indexes that are divisible by 8 (i.e., multiples of 8), among the tones having tone indexes ranging from −248 to 248, and, then, 0 may be mapped to the remaining tones. More specifically, in a 40 MHz channel, among the tones having tone indexes ranging from −248 to 248, a 2×HE-STF tone may be positioned at a tone index that is divisible by 8 excluding the DC. Herein, however, tones having tone indexes of ±248 correspond to guard tones (left and right guard tones), and such guard tones may be processed with nulling (i.e., such guard tones may have a value of 0). Accordingly, a total of 60 2×HE-STF tones having the 2×HE-STF sequence mapped thereto may exist in the 40 MHz channel.

Sub-drawing (c) of FIG. 14 illustrates an example of a 2×HE-STF tone in an 80 MHz PPDU transmission.

Referring to sub-drawing (c), in case a HE-STF sequence (i.e., 2×HE-STF sequence) for a periodicity of 1.6 μs is mapped to tones of an 80 MHz channel, the 2×HE-STF sequence is mapped to tones having tone indexes that are divisible by 8 (i.e., multiples of 8), among the tones having tone indexes ranging from −504 to 504, and, then, 0 may be mapped to the remaining tones. More specifically, in an 80 MHz channel, among the tones having tone indexes ranging from −504 to 504, a 2×HE-STF tone may be positioned at a tone index that is divisible by 8 excluding the DC. Herein, however, tones having tone indexes of ±504 correspond to guard tones (left and right guard tones), and such guard tones may be processed with nulling (i.e., such guard tones may have a value of 0). Accordingly, a total of 124 2×HE-STF tones having the 2×HE-STF sequence mapped thereto may exist in the 80 MHz channel.

Hereinafter, a sequence that is applicable to a 1×HE-STF tone and a sequence that is applicable to a 2×HE-STF tone are proposed. Most particularly, a basic sequence is configured, and a new sequence structure having excellent extendibility by using a nested structure including the corresponding sequence as part of a new sequence is proposed. It is preferable that the M sequence that is used in the following example corresponds to a sequence having a length of 15.

In a state when a detailed example of an M sequence is not proposed, a basic procedure for creating (or generating) a sequence in various bandwidths will hereinafter be described in detail.

A. Example of a 1×HE-STF tone

First of all, in case of the example of the 1×HE-STF tone, the following Equation may be created and used.

HE_STF_20 MHz(−112:16:+112)={M}

HE_STF_20 MHz(0)=0 <Equation 1>

The significance of HE_STF(A1:A2:A3)={M}, which is used in Equation 1 and the other equations shown below is as described below. First of all, the value of A1 signifies a frequency tone index corresponding to the first element of the M sequence, and the value of A3 signifies a frequency tone index corresponding to the last element of the M sequence. The value of A2 signifies a frequency tone index corresponding to each element of the M sequence being positioned at frequency tone intervals.

Accordingly, in Equation 1, the first element of the M sequence corresponds to the frequency band respective to index “−112”, the last element of the M sequence corresponds to the frequency band respective to index “+112”, and each element of the M sequence is positioned at 16 frequency tone intervals. Additionally, the value “0” corresponds to a frequency band respective to index “0” More specifically, Equation 1 has a structure respective to sub-drawing (a) of FIG. 13.

In order to extend the structure of Equation 1 to a 40 MHz band, {M, 0, M} may be used. Most particularly, a STF sequence of the 40 MHz band may be generated by using Equation 2 shown below.

HE_STF_40 MHz(−240:16:240)={c1*M,0,c2*M} <Equation 2>

Equation 2 corresponds to a structure, wherein 15 c1*M sequence elements are positioned within a frequency band range starting from a frequency band respective to index “−240” and up to a frequency band respective to index “−16” at 16 frequency tone intervals, wherein “0” is positioned with respect to frequency index 0, and wherein 15 c2*M sequence elements are positioned within a frequency band range starting from a frequency band respective to index “+16” and up to a frequency band respective to index “+240” at 16 frequency tone intervals “+16”.

In order to extend the structure of Equation 1 to an 80 MHz band, {M, 0, M, 0, M, 0, M} may be used. Most particularly, a STF sequence of the 80 MHz band may be generated by using Equation 3 shown below.

HE_STF_80 MHz(−496:16:496)={c1*M,a1,c2*M,0,c3*M,a2,c4*M} <Equation 3>

Equation 3 corresponds to a structure, wherein 15 M sequence elements are positioned within a frequency band range starting from a frequency band respective to index “−496” and up to a frequency band respective to index “−272” at 16 frequency tone intervals, wherein a value a1 is positioned with respect to frequency band respective to index “−256”, wherein 15 c2*M sequence elements are positioned within a frequency band range starting from a frequency band respective to index “−240” and up to a frequency band respective to index “−16” at 16 frequency tone intervals, and wherein “0” is positioned with respect to frequency index 0. Additionally, Equation 3 also corresponds to a structure, wherein 15 c3*M sequence elements are positioned within a frequency band range starting from a frequency band respective to index “+16” and up to a frequency band respective to index “+240” at 16 frequency tone intervals, wherein a value a2 is positioned with respect to frequency band respective to index “+256”, and wherein c4*M sequence elements are positioned from “+272” to “+496” at 16 frequency tone intervals.

It is preferable that detailed values of the M sequence, values a1 and a2, and coefficient values from c1 to c6 are optimized in light of PAPR. Meanwhile, in case of deciding the M sequence and other coefficients, a gamma value, which was used in the related art IEEE 802.11ac, may or may not be considered. In case of designing a STF sequence in the related art IEEE 802.11ac, a 20 MHz sequence was first designed, and, then, the 40 MHz and 80 MHz STF sequences were designed by multiplying the corresponding 20 MHz sequence by a predetermined phase shift sequence. More specifically, a method of creating a 40 STF MHz sequence by multiplying the 20 MHz STF sequence by [1, j] was used in IEEE 802.11ac. In an IEEE802.11ax or HEW system, since such gamma value may or may not be used, when calculating the PAPR, it is preferable to consider whether or not the gamma value has been applied.

Meanwhile, one of sqrt(½)*{1+j, 1−j, −1+j, −1−j} may be selected as the extra values, such as a1 and a2, and one of QPSK values (i.e., values 1, −1, j, and j) may be selected as the coefficient values c1 to c6. Sqrt( ) signifies a square root.

Diverse STF sequences may be generated in accordance with the above-described principle, and, among such STF sequences, an example of a STF sequence that is optimized in light of PAPR is proposed as described below.

First of all, the M sequence, which is essentially used, may be expressed as M_2 and may be decided in accordance with Equation 4 shown below.

M_2=[−1,−1−1+1+1+1−1,+1,+1+1−1+1+1−1,1]*(1+j)*sqrt(½) <Equation 4>

In this case, the STF sequence respective to the 20 MHz and 40 MHz bands may be decided in accordance with the equations shown below.

HE_STF_20 MHz(−112:16:112)=M_2

HE_STF_20 MHz(0)=0 <Equation 5>

HE_STF_40 MHz(−240:16:240)={M_2,0,jM_2} <Equation 6>

The significance of the variables used in the following equations is the same as those used in Equation 1 to Equation 3.

Meanwhile, the STF sequence respective to the 80 MHz band may be decided in accordance with any one of the equations shown below.

HE_STF_80 MHz(−496:16:496)={M_2,sqrt(½)*(1+j),jM_2,0,−jM_2,sqrt(½)*(−1−j),1M_2} <Equation 7>

HE_STF_80 MHz(−496:16:496)={M_2,sqrt(½)*(1+j),−M_2,0,−M_2,sqrt(½)*(1+j),1M_2} <Equation 8>

The significance of the variables used in the following equations is the same as those used in Equation 1 to Equation 3.

The above-described example corresponds to the example that is applicable to a 1×HE-STF signal. A 2×HE-STF signal will hereinafter be described in detail. More specifically, in a state when a detailed example of an M sequence is not proposed, a basic procedure for creating (or generating) a sequence in various bandwidths will hereinafter be described in detail beforehand.

B. Example of the 2×HE-STF Tone (1)

The basic structure of a sequence for the 20 MHz band may be the same as {M, 0, M}. More specifically, the following equations may be used. M is configured as a 15-bit sequence, and each element of the sequence may be configured to have diverse values.

HE_STF_20 MHz(−120:8:120)={c1*M,0,c2*M} <Equation 9>

Meanwhile, the basic structure of a sequence for the 40 MHz band may be configured by repeating the structure for the 20 MHz band. More specifically, in Example (1), which will hereinafter be described in detail, the structure of {M, 0, M, 0, M, 0, M} may be used. A more detailed structure may be the same as the equations shown below.

HE_STF_40 MHz(−248:8:248)={c1*M,a1,c2*M,0,c3*M,a2,c4*M} <Equation 10>

Meanwhile, the basic structure of a sequence for the 80 MHz band may be configured by repeating the structure for the 40 MHz band. More specifically, in Example (1), which will hereinafter be described in detail, the structure of {M, 0, M, 0, M, 0, M, 0, M, 0, M, 0, M, 0, M} may be used. A more detailed structure may be the same as the equations shown below.

HE_STF_80 MHz(−504:8:504)={c1*M,a1,c2*M,a2,c3*M,a3,c4*M,0,c5*M,a4,c6*M,a5,c7*M,a6,c8*M} <Equation 11>

The significance of the variables used in the Equation 9 to Equation 11 is the same as those used in Equation 1 to Equation 3.

It is preferable that the M sequence, coefficient values from c1 to c8, and extra values a1 to a6, which are used in the above-described Equation 9 to Equation 11, are decided based on the PAPR. In this case, in an IEEE802.11ax or HEW system, since such gamma value may or may not be used, when calculating the PAPR, it is preferable to consider whether or not the gamma value has been applied.

However, in case of Equations 10 and 11, due to the Guard band shown in FIG. 5 or FIG. 6, nulling should be carried out on the frequency tone indexes positioned at each end. More specifically, in case of the 40 MHz band, “0” should be positioned with respect to frequency indexes +248 and −248 instead of a c1*M value or a c4_M value. Additionally, in case of the 80 MHz band, “0” should be positioned with respect to frequency indexes +248 and −248 instead of a c1*M value or a c8_M value.

Diverse STF sequences may be generated in accordance with the above-described principle, and, among such STF sequences, an example of a STF sequence that is optimized in light of PAPR is proposed as described below.

First of all, in the following example, it is preferable that sequence (M_2), which is indicated in Equation 4, is used as the M sequence. In this case, the STF sequence respective to the 20 MHz, 40 MHz, and 80 MHz bands may be decided in accordance with the equations shown below.

HE_STF_20 MHz(−120:8:120)={M_2,0,−1M_2} <Equation 12>

HE_STF_40 MHz(−248:8:248)={M_2,sqrt(½)*(−1−j),−M_2,0,−jM_2,sqrt(½)*(−1+j),−jM_2}

HE_STF_40 MHz(±248)=0 <Equation 13>

HE_STF_80 MHz(−504:8:504)={M_2,sqrt(½)*(−1−j),1M_2,sqrt(½)*(1+j),1M_2,sqrt(½)*(1+j),−1M_2,0,1M_2,sqrt(½)*(−1−j),−1M_2,sqrt(½)*(−1−j),1M_2,sqrt(½)*(−1−j),1M_2}

HE_STF_80 MHz(±504)=0 <Equation 14>

The significance of the variables used in the following equations is the same as those used in Equation 1 to Equation 3.

As described above, in the example shown in Equation 13 and Equation 14, nulling is performed based on the guard bands of 40 MHz and 80 MHz. More specifically, as indicated in the Equation, the operations of “HE_STF_40 MHz(±248)=0” and “HE_STF_80 MHz(±504)=0” should be performed.

Proposed in the following example is an additional method that can design a STF sequence without any conflict (or collision) with the guard bands, even if nulling is not performed in the 40 MHz and 80 MHz bands.

C. Example of the 2×HE-STF Tone (2)

In the example presented above, since there was no nulling problem in the 20 MHz band, an example of resolving nulling in the 40 MHz and 80 MHz bands will hereinafter be proposed.

The basic structure of a sequence for the 40 MHz band may be configured by repeating the structure for the 20 MHz band. More specifically, in Example (2), which will hereinafter be described in detail, the structure of {M, M, 0, M, M} may be used. A more detailed structure may be the same as the equations shown below.

HE_STF_40 MHz(−240:8:240)={c1*M,c2*M,0,c3*M,c4*M} <Equation 15>

Meanwhile, the basic structure of a sequence for the 80 MHz band may be configured by repeating the structure for the 40 MHz band. More specifically, the structure of {M, M, 0, M, M, x1, 0, x2, M, M, 0, M, M} may be used. “x1” and “x2” may be configured as extra values, which will be described later on, based on the PAPR.

A more detailed structure may be the same as the equations shown below.

HE_STF_80 MHz(−496:8:496)={c1*M,c2*M,a1,c3*M,c4*M,x1,0,x2,c5*M,c6*M,a2,c7*M,c8*M} <Equation 16>

HE_STF_80 MHz(−496:8:496)={x1,c1*M,c2*M,a1,c3*M,c4*M,0,c5*M,c6*M,a2,c7*M,c8*M,x2} <Equation 17>

The significance of the variables used in the Equation 15 to Equation 17 is the same as those used in Equation 1 to Equation 3. It is preferable that the M sequence, coefficient values from c1 to c8, and extra values a1, a2, x1, and x2, which are used in the above-described Equation 15 to Equation 17, are decided based on the PAPR. In this case, in an IEEE802.11ax or HEW system, since such gamma value may or may not be used, when calculating the PAPR, it is preferable to consider whether or not the gamma value has been applied. Meanwhile, any one of sqrt(½)*{1+j, 1−j, −1+j, −1−j} may be decided as each of the values x1 and x2, which are proposed in Equation 15 to Equation 17.

Diverse STF sequences may be generated in accordance with the above-described principle, and, among such STF sequences, an example of a STF sequence that is optimized in light of PAPR is proposed as described below.

First of all, in the following example, it is preferable that sequence (M_2), which is indicated in Equation 4, is used as the M sequence. In this case, the STF sequence respective to the 40 MHz, which does not required nulling, may be decided in accordance with the equations shown below.

HE_STF_40 MHz(−240:8:240)={M_2,−1M_2,0,−jM_2,−jM_2} <Equation 18>

Meanwhile, one of the diverse examples presented below may be selected and used with respect to the 80 MHz band.

HE_STF_80 MHz(−496:8:496)={M_2,−1M_2,sqrt(½)*(−1−j),−1M_2,−1M_2,sqrt(½)*(−1−j),0,sqrt(½)*(−1−j),−1M_2,1M_2,sqrt(½)*(−1−j),1M_2,1M_2} <Equation 19>

HE_STF_80 MHz(−496:8:496)={M—2,−1M—2,sqrt(½)*(1+j),jM_2,jM_2,sqrt(½)*(1+j),0,sqrt(½)*(1+j),1M—2,−1M—2,sqrt(½)*(−1−j),jM_2,jM_2}

HE_STF_80 MHz(−496:8:496)={sqrt(½)*(−1−j),M_2,−1M_2,sqrt(½)*(1+j),−1M_2,−1M_2,0,−1M_2,1M_2,sqrt(½)*(−1−j),1M_2,1M_2,sqrt(½)*(−1−j)} <Equation 21>

HE_STF_80 MHz(−496:8:496)={sqrt(½)*(1+j),−1M_2,1M_2,sqrt(½)*(−1−j),1M_2,1M_2,0,1M_2,−1M_2,sqrt(½)*(1+j),−1M_2,−1M_2,sqrt(½)*(1+j)} <Equation 22>

HE_STF_80 MHz(−496:8:496)={sqrt(½)*(−1−j),M_2,jM_2,sqrt(½)*(1−j),jM_2,1M_2,0,jM_2,1M_2,sqrt(½)*(−1−j),1M_2,jM_2,sqrt(½)*(1−j)} <Equation 23>

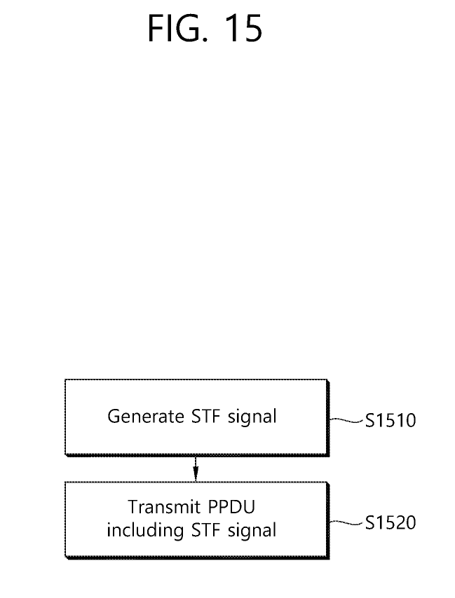

FIG. 15 is a flow chart of a procedure according to an exemplary embodiment of the present invention. The process steps of FIG. 15 indicate operations that are carried out by the transmitting device, which corresponds to an AP or a non-AP STA.

As shown in the drawing, in step S1510, a STF signal is generated.

It is preferable that the STF signal, which is generated in step S1510, is used for any one band among the multiple bands. More specifically, it is preferable that the generated STF signal corresponds to a signal for a first frequency band, which is 20 MHz, a second frequency band, which is 40 MHz, and a third frequency band, which is 80 MHz. Additionally, in case of generating a STF for an uplink MU PPDU corresponding to the trigger frame, it preferable to generate a 2×STF signal having a frequency index interval set to 8 in the tone to which the STF signal is mapped. And, otherwise, it is preferable to generate a 1×STF signal having a frequency index interval set to 16.

It is preferable that the STF signal is generated based on a predetermined M sequence. The M sequence may correspond to a 15-bit sequence. More specifically, the M sequence may correspond to a sequence that is defined as {−1, −1, −1, 1, 1, 1, −1, 1, 1, 1, −1, 1, 1, −1, 1}*(1+j)+sqrt(½).

In case the STF signal that is generated through step S1510 is being used for the first frequency band, the STF signal may be generated from a {C1*M, 0, C2*M} sequence. Additionally, in case the STF signal that is generated through step S1510 is being used for the second frequency band, the STF signal may be generated from a {C3*M, C4*M, 0, C5*M, C6*M} sequence.

The {C1*M, 0, C2*M} sequence may correspond to a sequence being configured of a 8-tone interval from a minimum tone having a tone index of −112 to a maximum tone having a tone index of +112. Additionally, the {C3*M, C4*M, 0, C5*M, C6*M} sequence may correspond to a sequence being configured of a 8-tone interval from a minimum tone having a tone index of −240 to a maximum tone having a tone index of +240. Additionally, the {C1*M, 0, C2*M} sequence may be configured of {M, 0, −M}, and the {C3*M, C4*M, 0, C5*M, C6*M} sequence may be configured of {M, −M, 0, −jM, −jm}.

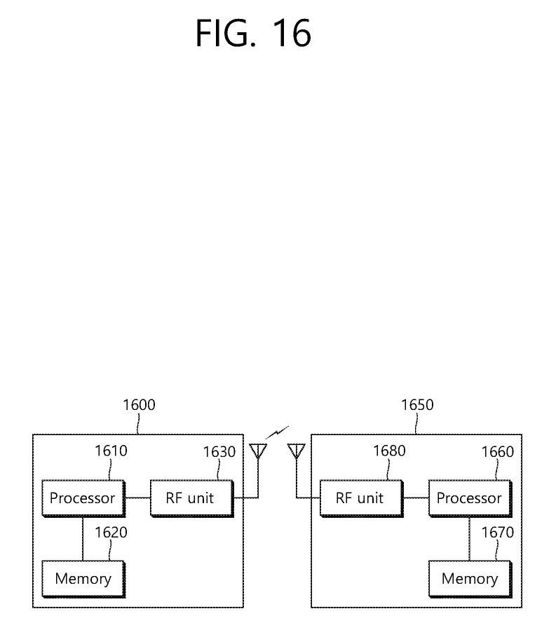

FIG. 16 is a block diagram showing a wireless communication system in which the exemplary embodiment of the present invention can be applied.

Referring to FIG. 16, as a station (STA) that can realize the above-described exemplary embodiment, the wireless device may correspond to an AP or a non-AP station (non-AP STA). The wireless device may correspond to the above-described user or may correspond to a transmitting device transmitting a signal to the user.

The AP 1600 includes a processor 1610, a memory 1620, and a radio frequency unit (RF unit) 1630.

The RF unit 1630 is connected to the processor 1610, thereby being capable of transmitting and/or receiving radio signals.

The processor 1610 implements the functions, processes, and/or methods proposed in this specification. For example, the processor 1610 may be realized to perform the operations according to the above-described exemplary embodiments of the present invention. More specifically, the processor 1610 may perform the operations that can be performed by the AP, among the operations that are disclosed in the exemplary embodiments of FIG. 1 to FIG. 15.

The non-AP STA 1650 includes a processor 1660, a memory 1670, and a radio frequency unit (RF unit) 1680.

The RF unit 1680 is connected to the processor 1660, thereby being capable of transmitting and/or receiving radio signals.

The processor 1660 may implement the functions, processes, and/or methods proposed in the exemplary embodiment of the present invention. For example, the processor 1660 may be realized to perform the non-AP STA operations according to the above-described exemplary embodiments of the present invention. The processor may perform the operations of the non-AP STA, which are disclosed in the exemplary embodiments of FIG. 1 to FIG. 15.

The processor 1610 and 1660 may include an application-specific integrated circuit (ASIC), another chip set, a logical circuit, a data processing device, and/or a converter converting a baseband signal and a radio signal to and from one another. The memory 1620 and 1670 may include a read-only memory (ROM), a random access memory (RAM), a flash memory, a memory card, a storage medium, and/or another storage device. The RF unit 1630 and 1680 may include one or more antennas transmitting and/or receiving radio signals.

When the exemplary embodiment is implemented as software, the above-described method may be implemented as a module (process, function, and so on) performing the above-described functions. The module may be stored in the memory 1620 and 1670 and may be executed by the processor 1610 and 1660. The memory 1620 and 1670 may be located inside or outside of the processor 1610 and 1660 and may be connected to the processor 1610 and 1660 through a diversity of well-known means.

As described above, the method and device for generating a sequence for a STF field in a wireless LAN system have the following advantages.

According to an example of this specification, a method for generating a STF signal that is available for usage in a wireless LAN system is proposed herein.

The method for generating a STF signal, which is proposed in the example of this specification, resolves the problems occurring in the method that was proposed in the related art.

Although the aforementioned exemplary system has been described on the basis of a flowchart in which steps or blocks are listed in sequence, the steps of the present invention are not limited to a certain order. Therefore, a certain step may be performed in a different step or in a different order or concurrently with respect to that described above. Further, it will be understood by those ordinary skilled in the art that the steps of the flowcharts are not exclusive. Rather, another step may be included therein or one or more steps may be deleted within the scope of the present invention.

What is claimed is:

1. As a method for configuring a physical layer protocol data unit (PPDU) in a wireless LAN system, the method comprising:
configuring, by a transmitting device, a short training field (STF) signal being used for enhancing automatic gain control (AGC) estimation of a multiple input multiple output transmission (MIMO transmission); and
transmitting, by the transmitting device, a PPDU including the STF signal to a receiving device,
wherein the STF signal is used for at least any one of a first frequency band and a second frequency band, and wherein a bandwidth of the second frequency band is two times larger than a bandwidth of the first frequency band,
wherein the STF signal is generated based on a M sequence,
wherein, in case the STF signal is being used for the first frequency band, the STF signal is generated from a {C1*M, 0, C2*M} sequence, and C1 and C2 are coefficients,
wherein, in case the STF signal is being used for the second frequency band, the STF signal is generated from a {C3*M, C4*M, 0, C5*M, C6*M} sequence, and C3, C4, C5, and C6 are coefficients,
wherein the M sequence is defined as shown below:
M={−1, −1, −1, 1, 1, 1, −1, 1, 1, 1, −1, 1, 1, −1, 1}*(1+j)+sqrt(½), and
wherein sqrt( ) represents a square root.

2. The method of claim 1, wherein the {C1*M, 0, C2*M} sequence corresponds to a sequence being configured of an 8-tone interval starting from a minimum tone having a tone index of −112 up to a maximum tone having a tone index of +112, and
wherein the {C3*M, C4*M, 0, C5*M, C6*M} sequence corresponds to a sequence being configured of an 8-tone interval starting from a minimum tone having a tone index of −240 up to a maximum tone having a tone index of +240.

3. The method of claim 1, wherein the first frequency band corresponds to a 20 MHz band, and the second frequency band corresponds to a 40 MHz band.

4. The method of claim 1, wherein each of C1 to C6 is configured as a QPSK value.

5. The method of claim 1, wherein the {C1*M, 0, C2*M} sequence is configured of {M, 0, −M}, and
wherein the {C3*M, C4*M, 0, C5*M, C6*M} sequence is configured of {M, −M, 0, −jM, −jM}.

6. The method of claim 1, wherein the PPDU corresponds to an uplink MU PPDU being transmitted from an AP with respect to a received trigger frame.

7. The method of claim 1, wherein the STF signal has a periodicity of 1.6 μs.

8. As a receiving device in a wireless LAN system, the device comprising:
a radio frequency unit (RF unit) configured to transmit or receive radio signals; and
a processor configured to control the RF unit,
wherein the processor:
configures a STF signal being used for enhancing automatic gain control (AGC) estimation of a multiple input multiple output transmission (MIMO transmission), and
controls the RF unit so as to transmit a PPDU including the STF signal to a receiving device,
wherein the STF signal is used for at least any one of a first frequency band and a second frequency band, and wherein a bandwidth of the second frequency band is two times larger than a bandwidth of the first frequency band,
wherein the STF signal is generated based on a M sequence,
wherein, in case the STF signal is being used for the first frequency band, the STF signal is generated from a {C1*M, 0, C2*M} sequence, and C1 and C2 are coefficients,
wherein, in case the STF signal is being used for the second frequency band, the STF signal is generated from a {C3*M, C4*M, 0, C5*M, C6*M} sequence, and C3, C4, C5, and C6 are coefficients,
wherein the M sequence is defined as shown below:
M={−1, −1, −1, 1, 1, 1, −1, 1, 1, 1, −1, 1, 1, −1, 1}*(1+j)+sqrt(½), and
wherein sqrt( ) represents a square root.

9. The device of claim 8, wherein the {C1*M, 0, C2*M} sequence corresponds to a sequence being configured of an 8-tone interval starting from a minimum tone having a tone index of −112 up to a maximum tone having a tone index of +112, and
wherein the {C3*M, C4*M, 0, C5*M, C6*M} sequence corresponds to a sequence being configured of an 8-tone interval starting from a minimum tone having a tone index of −240 up to a maximum tone having a tone index of +240.

10. The device of claim 8, wherein the first frequency band corresponds to a 20 MHz band, and the second frequency band corresponds to a 40 MHz band.

11. The device of claim 8, wherein each of C1 to C6 is configured as a QPSK value.

12. The device of claim 8, wherein the {C1*M, 0, C2*M} sequence is configured of {M, 0, −M}, and
wherein the {C3*M, C4*M, 0, C5*M, C6*M} sequence is configured of {M, −M, 0, −jM, −jM}.

13. The device of claim 8, wherein the PPDU corresponds to an uplink MU PPDU being transmitted from an AP with respect to a received trigger frame.

14. The device of claim 8, wherein the STF signal has a periodicity of 1.6 μs.
